(19) United States
(12) Patent Application Publication
(10) Pub. No.: US 2017/0032823 A1
(43) Pub. Date: Feb. 2, 2017

(54) SYSTEM AND METHOD FOR AUTOMATIC VIDEO EDITING WITH NARRATION

(71) Applicant: MAGISTO LTD., Nes-Ziona (IL)

(72) Inventors: Alexander RAV-ACHA, Rehovot (IL); Oren BOIMAN, Sunnyvale, CA (US)

(21) Appl. No.: 15/292,894

(22) Filed: Oct. 13, 2016

Related U.S. Application Data
(63) Continuation-in-part of application No. 14/994,219, filed on Jan. 13, 2016, now Pat. No. 9,524,752.
(60) Provisional application No. 62/103,588, filed on Jan. 15, 2015.
(60) Provisional application No. 62/241,159, filed on Oct. 14, 2015.

(51) Int. Cl. G11B 27/031; G10L 15/04; G10L 21/055; G10L 15/08; G06K 9/00; H04N 5/262

(52) U.S. Cl. CPC G11B 27/031; G06K 9/00765; G06K 9/00718; H04N 5/2628; G10L 21/055; G10L 15/08; G10L 15/04; G10L 2015/088

(57) ABSTRACT

A method and a system for automatic video editing with narration are provided herein. The method may include: obtaining a plurality of media entities comprising at least one video entity having a visual channel and an audio channel; analyzing the media entities, to produce content-related media meta data indicative of a content of the media entities; automatically selecting media portions from the plurality of media entities, wherein at least one media portion is a subset of the said video entity of said plurality of media entities; receiving from a user a narration being a media entity comprising at least one audio channel; and automatically combining the narration and the selected media portions, to yield a narrated video production, wherein the combining is based on the content-related media meta data. The system implements the aforementioned method.

### CROSS-REFERENCE TO RELATED APPLICATIONS

This Application is a Continuation-in Part of U.S. patent application Ser. No. 14/994,219 filed on Jan. 13, 2016, now allowed, which claims priority from U.S. Provisional Patent Application No. 62/103,588, filed on Jan. 15, 2015, and further claims priority from U.S. Provisional Patent Application No. 62/241,159, filed on Oct. 14, 2015, each of which is incorporated herein by reference in its entirety.

### FIELD OF THE INVENTION

The present invention relates generally to the field of video editing, and more particularly to automatic selection of video and audio portions and generating a video production from them.

### BACKGROUND OF THE INVENTION

Prior to the background of the invention being described, it may be helpful to set forth definitions of certain terms that will be used hereinafter.

The term ‘video production’ as used herein is the process of creating video by capturing moving images (videography), and creating combinations and reductions of parts of this video in live production and post-production (video editing). In most cases, the captured video will be recorded on electronic media such as video tape, hard disk, or solid state storage, but it might only be distributed electronically without being recorded. It is the equivalent of filmmaking, but with images recorded electronically instead of film stock.

The term ‘narration’ as used herein is a media entity that includes at least one audio channel which includes a voice of a narrator speaker who possibly describes other media entities.

Video editing is the process of generating a video compilation from a set of photos and/or videos. Generally speaking, it includes selecting the best footage, adding transitions and effects, and usually also adding music, to yield an edited video clip also referred herein as video production.

In many cases, the edited video may be improved by adding a narration—an audio track recorded by the user, which may tell, for example, the story behind this edited video. The narration may also be a video by itself (i.e., have both visual and audio channels), in which case it usually displays the talking person.

Automatically integrating a narration into an edited video may involve several technical challenges—for example, how to handle conflicts between the narration and the audio track of the original video, how to mix the audio track of the narration (and optionally the visual track) of the edited video, how to modify the edited video to match the narration, and in some cases how to modify the narration to match the edited video and the like.

### SUMMARY OF THE INVENTION

In accordance with some embodiments of the present invention, an automatic combining of media entities and a narration, based on analyzed Meta data, is provided herein.

Some embodiments of the present invention provide a method for smart integration of a narration into the video editing process, based on an analysis of the footage (either the audio or the visual tracks) and/or analysis of the added narration. Some of the challenges addressed by the aforementioned smart integration are:
Automatically adjusting the volume of the audio channel of the video vs. the narration to avoid conflicts (e.g.—overlapping speech);
Ways to integrate a video narration, e.g.—using a narration window, B-roll, and the like;
Possible re-editing of the input footage to match the added narration; and
Possible editing of the narration to match the edited video.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a block diagram illustrating a non-limiting exemplary system in accordance with some embodiments of the present invention;

FIG. 1B is a block diagram illustrating a non-limiting exemplary system in accordance with some embodiments of the present invention;

FIG. 1C is a block diagram illustrating a non-limiting exemplary system in accordance with some embodiments of the present invention;

FIG. 2A is a flow chart diagram illustrating a non-limiting exemplary embodiment in accordance with some embodiments of the present invention;

FIG. 2B is a flow chart diagram illustrating a non-limiting exemplary embodiment in accordance with some embodiments of the present invention;

FIG. 2C is a flow chart diagram illustrating a non-limiting exemplary embodiment in accordance with some embodiments of the present invention;

FIG. 3 is a timeline diagram illustrating a non-limiting exemplary aspect in accordance with some embodiments of the present invention;

FIG. 3 is a timeline diagram illustrating a non-limiting exemplary aspect in accordance with some embodiments of the present invention;

FIGS. 4A and 4B are frame diagrams illustrating yet another non-limiting exemplary aspect in accordance with some embodiments of the present invention;

FIG. 5 is a timeline diagram illustrating a non-limiting exemplary aspect in accordance with some embodiments of the present invention;

FIG. 6A is a timeline diagram illustrating another non-limiting exemplary aspect in accordance with some embodiments of the present invention;

FIG. 6B is a timeline diagram illustrating yet another non-limiting exemplary aspect in accordance with some embodiments of the present invention; and

FIG. 7 is a timeline diagram illustrating yet another non-limiting exemplary aspect in accordance with some embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Automatic video editing is a process in which a raw footage that includes videos and photos is analyzed, and portions from that footage are selected and produced together to create an edited video. Sometimes, an additional music soundtrack is attached to the input footage, resulting in a music clip that mixes the music and the videos/photos together.

A common flow for automatic video editing (but not the only possible flow) is:
Analyzing the input footage.
Automatic selection of footage portions and decision making
Adding transitions and effects and rendering the resulting edited video.

The automation selection and decision making stage usually consists of:
Selecting the best portions of the videos and photos.
Determine the ordering of these portions in the edited video.
For each video portion, deciding whether the audio of this video will be played or not (or a more general mix with the soundtrack).

In accordance with some embodiments of the present invention, it is suggested to allow a user to add narration contextually related to the media portions. Various embodiments of the present invention turn the input of the media portions and the narration into a narrated video production.

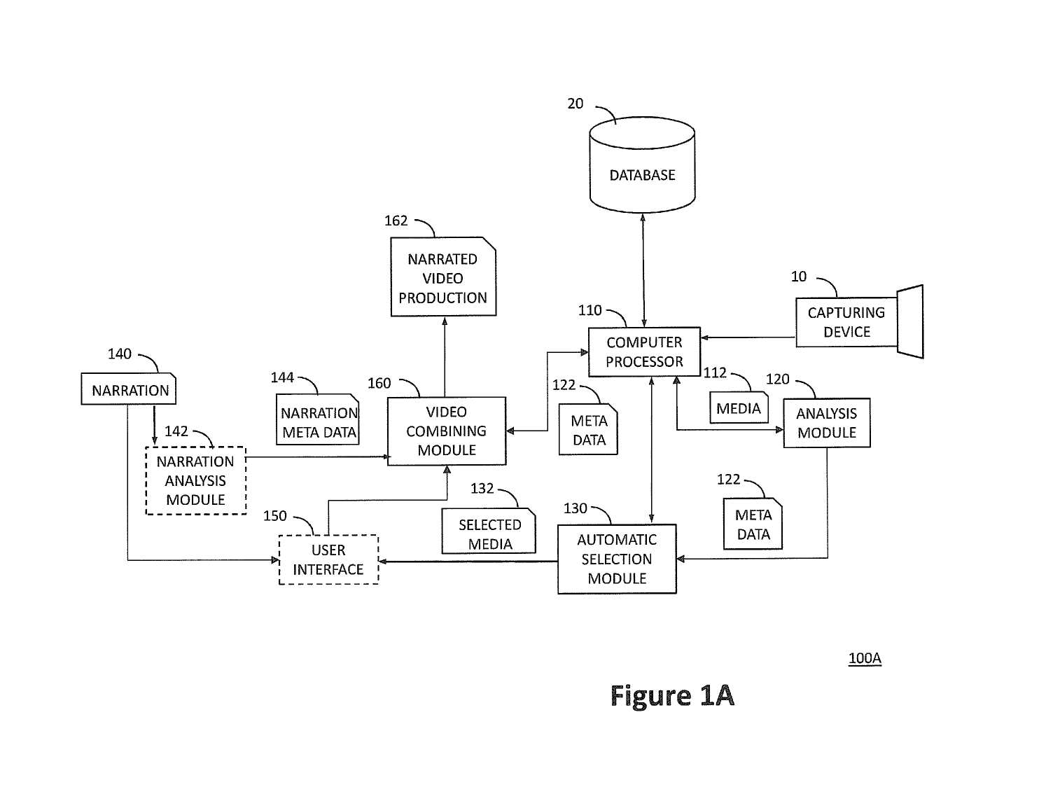

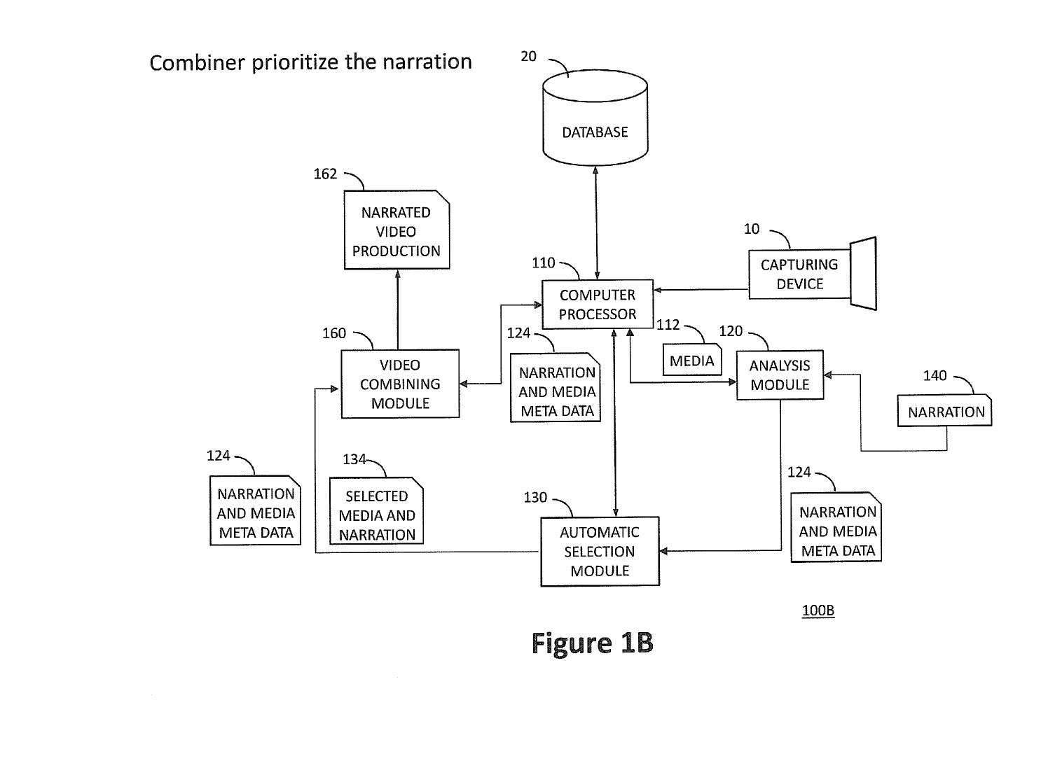

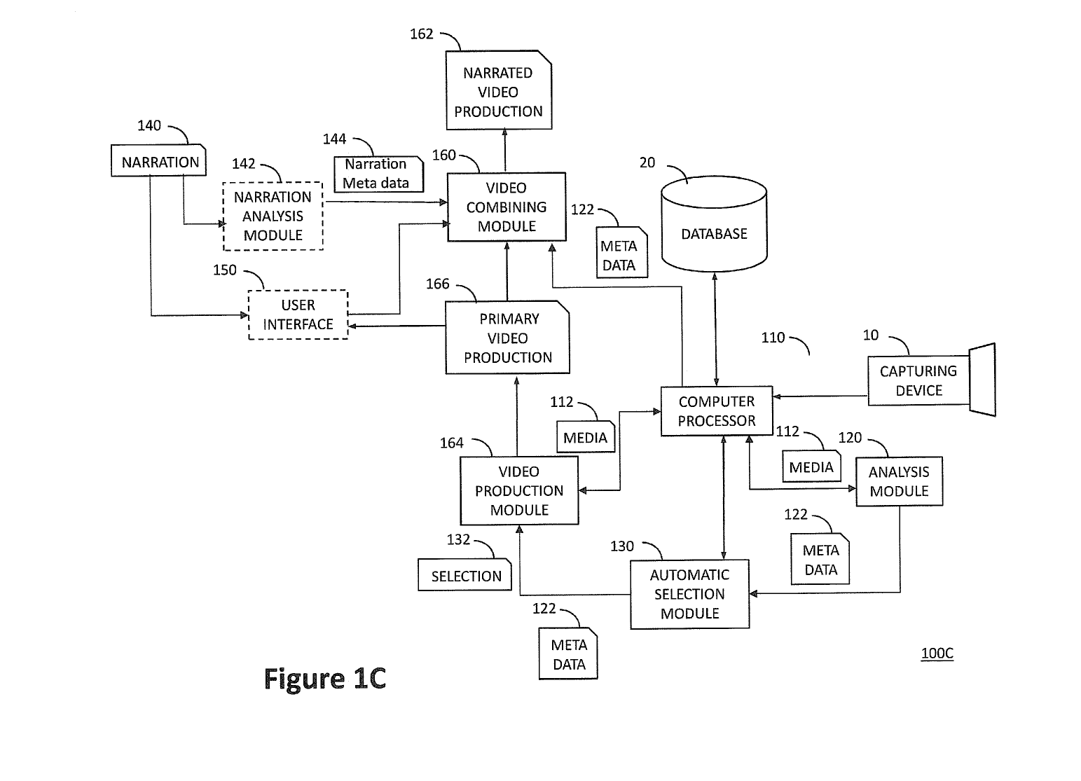

FIG. 1A is a block diagram illustrating a non-limiting exemplary system in accordance with some embodiments of the present invention. System 100A includes a computer processor 110 connectable to a database 20 configured to store a plurality of media entities 112 comprising at least one video entity having a visual channel and an audio channel and possibly to a capturing device 10 which may be configured to capture such media entities 112. System 100A may further include an analysis module 120 executed by computer processor 110 and configured to analyze media entities 112, to produce content-related media meta data 122 indicative of a content of the media entities 112. System 100A may further include an automatic selection module 130 executed by computer processor 110 and configured to automatically select media portions from the plurality of media entities 112, wherein at least one media portion is a subset of the video entity of the plurality of media entities.

System 100A may further include a user interface 150 configured to receive from a user a narration 140 being a media entity comprising at least one audio channel.

System 100A may further include a video production module 160 executed by computer processor 110 and configured to automatically combine narration 140 and the selected media portions 132, to yield a narrated video production 162, wherein the combining is based on the content-related media meta data 122.

In some embodiments, system 100A may further include a narration analysis module configured to derive narration meta data 144 from narration 140 wherein narration meta data 144 are further used to combine the selected media entities 132 with the narration 140.

In some embodiments, user interface 150 may be used to receive input from a human user in which he or she associates narration portions with respective media portions which are contextually related. This association is further used in the video production process carried out.

FIG. 1B is a block diagram illustrating a non-limiting exemplary system in accordance with some embodiments of the present invention. System 100B is similar to aforementioned system 100A but here narration 140 is fed into analysis module as soon as media entities are fed into it, to derive combined narration and media meta data which are then used by automatic selection module to carry out the automatic selection of the media entities. The selected media together with the narration and media meta data are then used by video combining module 160 to generate the narrated video production 162. It should be noted that, in some embodiments, selection module 130 and video combining module 160 may be implemented as a single module.

FIG. 1C is a block diagram illustrating a non-limiting exemplary system in accordance with some embodiments of the present invention. System 100B is similar to aforementioned system 100A but here a video production module 164 is used to produce a primary video production 166 based on selection 132 of media entities and meta data 122. Primary video production 166 is then shown to the user over a user interface which is further used to add narration 140 which is subsequently being combined with the primary video production 166 by video combining module 160 (either with or without narration metadata 144 derived by narration analysis module 142) to form a narrated video production 162.

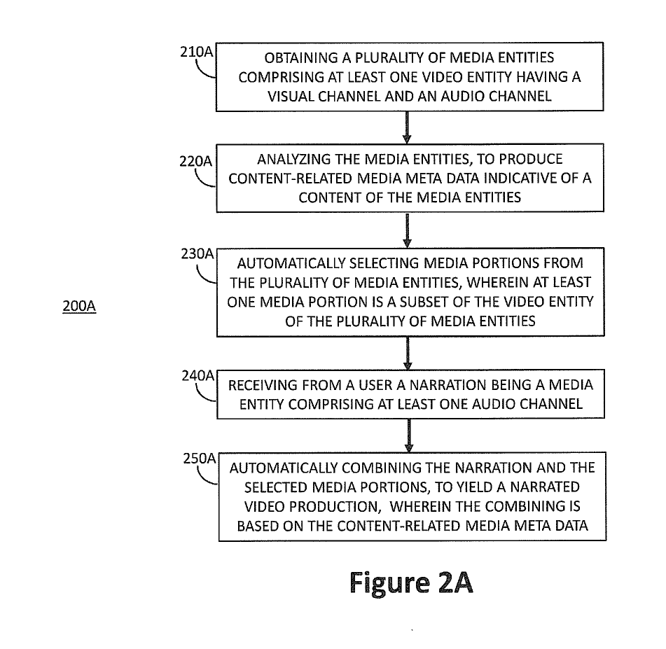

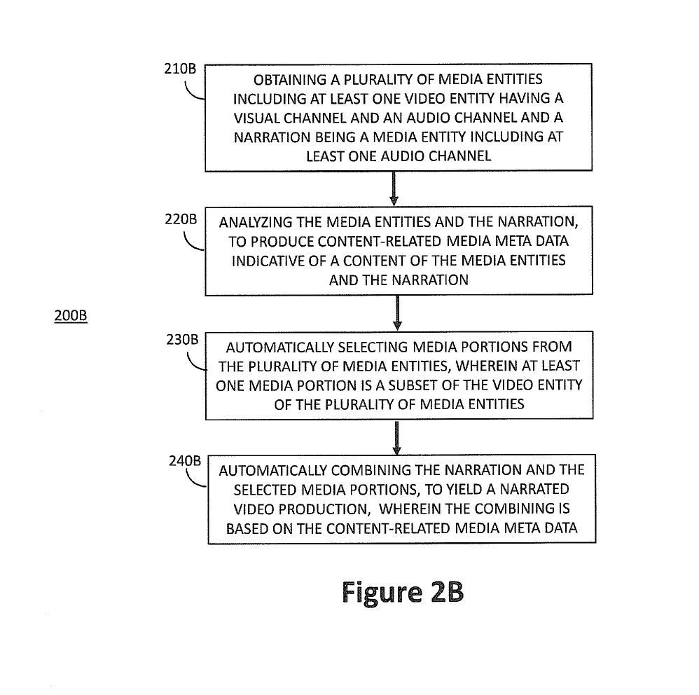

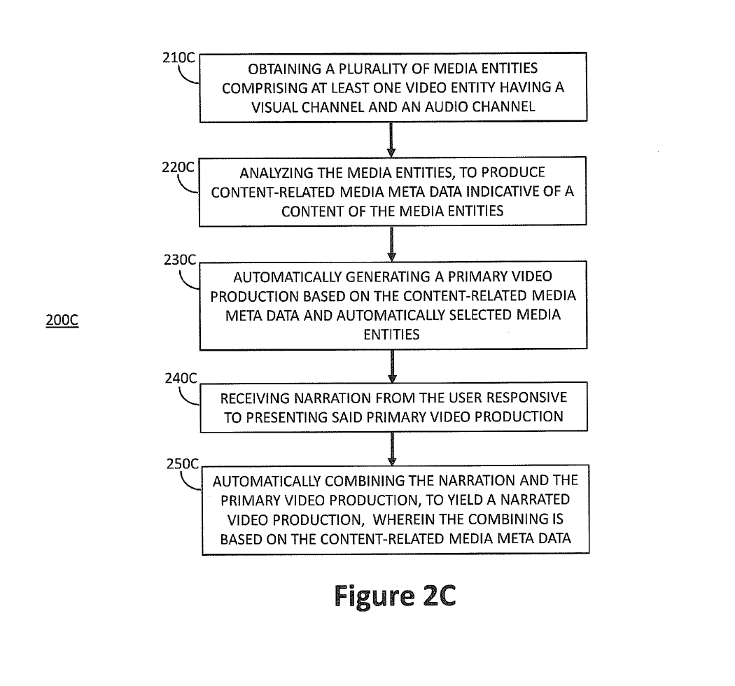

FIG. 2A is a flow chart diagram illustrating a non-limiting exemplary embodiment in accordance with some embodiments of the present invention. Method 200A may include the following steps: obtaining a plurality of media entities comprising at least one video entity having a visual channel and an audio channel 210A; analyzing the media entities, to produce content-related media meta data indicative of a content of the media entities 220A; automatically selecting media portions from the plurality of media entities, wherein at least one media portion is a subset of the video entity of the plurality of media entities 230A; receiving from a user an attachment of a narration, being a media entity comprising at least one audio channel 240A; and automatically combining the narration and the selected media portions, to yield a narrated video production, wherein the combining is based on the content-related media meta data 250A.

FIG. 2B is a flow chart diagram illustrating a non-limiting exemplary embodiment in accordance with some embodiments of the present invention. Method 200A may include the following steps: obtaining a plurality of media entities including at least one video entity having a visual channel and an audio channel and a narration being a media entity including at least one audio channel 210B; analyzing the media entities and the narration, to produce content-related media meta data indicative of a content of the media entities and the narration 220B; automatically selecting media portions from the plurality of media entities, wherein at least one media portion is a subset of the video entity of the plurality of media entities 230B; and automatically combining the narration and the selected media portions, to yield a narrated video production, wherein the combining is based on the content-related media meta data 240B.

FIG. 2C is a flow chart diagram illustrating a non-limiting exemplary embodiment in accordance with some embodiments of the present invention. Method 200C may include the following steps: obtaining a plurality of media entities comprising at least one video entity having a visual channel and an audio channel 210C; analyzing the media entities, to produce content-related media meta data indicative of a content of the media entities 220C; automatically generating a primary video production based on the content-related media meta data and automatically selected media entities 230C; receiving narration from the user responsive to presenting said primary video production 240C; and automatically combining the narration and the primary video production, to yield a narrated video production, wherein the combining is based on the content-related media meta data 250C.

### Video Editing Given the Narration

The video editing algorithm itself can be adjusted to take into consideration an added narration.

The first possible influence of the narration on the editing is by adjusting the temporal ordering and positioning of the selected portions (from the user footage) such that:

If audio portions from the user's video are selected (and played), they will not collide with the narration speech.

Based on speech recognition of the narration audio track, the narration can be synchronized with various objects in the user's footage, improving the cross-relation between the footage and the narration. Such objects may be object classes like “Cat”, “Kitchen”, “Person”, etc., or even specific objects such as “George”, “my kid”, etc. (in which case a face recognition can be used to identified these objects). In addition to objects, other entities can be synchronized too, such as actions (“Pour the milk”, “Smile”, etc.), Scenes (“Sea”), Attributes (“Dark”).

Another way for improve the video editing based on the added narration is in the production stage, in which visual effects and transitions are. These visual effects and transitions can be influenced by the narration. For example, adding effects that correspond to the content of the narration according to an auditory or visual analysis of the narration. For example—adding hearts when the word “Love” is detected in the narration, or when a kiss action is detected in it. Another example is adding a visual effect that result from a detection of a cry or a laugh in the narration.

The video editing can be modified based on the narration in various other ways: Adjusting the duration of the resulting video based on the narration, avoiding selecting portions with speech in the edited video if they are expected to collide with the narration, selecting the best (or most emotional) parts for the edited video to appear during the most emotional parts of the narration (e.g., cry, laugh, etc.), or more generally—matching an importance score on the edited user footage to an importance score on the narration, so that the emotional peaks are synchronized between the narration and the edited video.

In a use case in which the narrations are attached to selected media portions, the editing can be affected by the narration in more ways. For example, one criterion is to simply adjust the photo and clip selections of the edited video to match the duration of the attached narrations (for example—assume that a narration is attached to a photo or a video portion, it would be beneficial to show this photo or video portion for at least as much time as the duration of this attached narration). Another criterion is to give a higher priority for selecting footage that was attached with a narration (as the user probably wants these parts to appear in the edited video).

### Modifying the Narration Based on the Edited Video

In some scenarios, the narration itself may be edited. The simple modification is separating the narration to several parts, and adding them to the edited video at different time locations (an equivalent way to think about it is a process of adding spaces between different parts of the narration). The separation to several parts will usually be done while respecting the speech in the narration, for example—not cutting the narration in the middle of a sentence.

The separation of the narration to several parts may follow the following logics and reasoning:
To improve the matching between the narration and the edited video, the narration can further be modified to match the edited video. Examples for such a criteria are: avoiding collisions between the narration and the edited video, matching the content or the emotional climax between portions of the narration and of the user footage such that related portions are played at the same time (in the resulting video), and the like; and
Separating the narration to several portions can also be used to improve the temporal spreading of the narration across the resulting video, for example—playing parts of the narration in the begging and at the end of the resulting video (or close to the begging and the end).

### User Flows for Adding a Narration

There are several possibilities for building the user flow for adding a narration. The first option is to let the user add the narration together with the rest of the footage (and the accompanied music track). The advantage of this approach is the simplicity of the flow, but its disadvantage is that the user is not able to synchronize his narration with the edited video. One possible solution is to record the narration in parts (e.g., for each photo and video) and put the recorded narration parts in the corresponding locations in the edited video. Another solution (with less manual effort) is trying to automatically synchronize the narration with the content, for example, based on visual analysis of the content.

Another alternative is to add the narration only after the video was edited and produced. In this case, the user may be able to watch the produced video and record a narration simultaneously (in which case, the audio track of the edited video is muted during recording). This process may be done iteratively, where the user is able to see the modified produced video (consisting also of the narration) and record the narration again (or modify it). The advantage of this approach is that the user is able to synchronize his narration with the produced video.

Several alternatives for a user flow for adding a narration:
The user adds the narration together with the rest of the footage (and the accompanied music track), and the editing is done taking both the input footage, the music and the narration into account;
The user added the narration only after he sees the edited video, so he can record the narration while watching the video, and synchronize both. The steps of video editing and adding a narration can be iterated (in which case, the video editing consists also of mixing the narration); and
Narrations are attached to one or more photos or video portions from the automatically selected media portions. In this case, the video-editing includes adding the narration to the relevant selections, to yield the resulting video production.

### Audio Narration

The simplest scenario is when the narration consists only of audio, and assuming that the video is already edited and cannot be modified. In this case, the integration of the narration into the edited video consists of correctly mixing the audio channel of the original edited video and the narration. The volume of the audio in continuously adjusted to avoid confusions with the narration. In this example, the adjustment is done based on a simple logic that relies on a speech detection applied on the narration audio track—for speech periods in the narration, the volume of the original audio channel is reduced, and for non-speech periods (e.g., between sentences), the volume of the original audio channel is kept (or reduced more moderately). There are various methods for speech detection and recognition

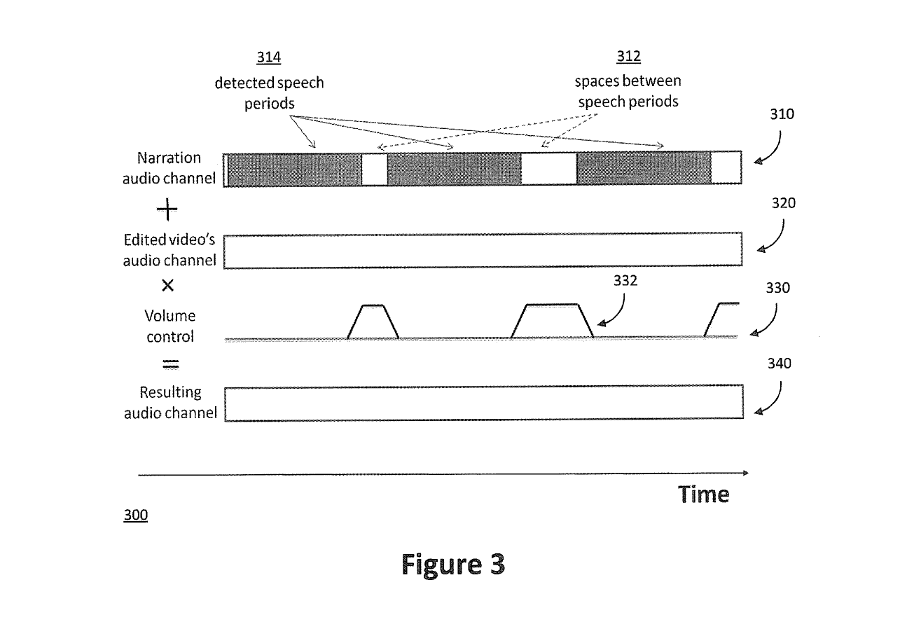

FIG. 3 is a timeline diagram 300 illustrating the volume adjustment may be smoothed using various functions (in this example—linear smoothing) to avoid rapid volume changes. Narration 310 is analyzed to detect speech periods 314 and spaces between speech periods 312. Edited video's channel 320 is also analyzed and a volume control channel 330 is used in order to make sure the narration overrides the edited video's audio channel at the detected speech periods to yield a resulting audio channel 340.

The resulting audio channel is a mixture of the narration audio channel, and the audio channel of the edited video. In this example, the volume of the audio of the edited video in continuously adjusted (by changing its volume) to avoid confusions with the narration and the adjustment logic is based on speech detection: the volume of the audio channel of the edited video is reduced at periods of speech in the narration.

### Re-Editing the Audio of the Edited Video

In the aforementioned embodiment, the only modification applied on the audio of the edited video was adjusting its volume. A more complicated approach is to re-edit the audio channel of the edited video based also on the analysis of the user footage that was used to create this edited video. Examples for such generalization of the simple mixing are:

Assuming that the edited video consist of a set of selected video portions, the mixture may be determined also as a function of the clip selection of the video editing—for example, muting the sounds of some selected video portions, while keeping the volume of the sounds for others. In this way, the volume mixture respects the cuts between video selections.

In addition, the audio channel of the user's footage can be analyzed to separate speech into words & sentences, and use this separation to control the audio mixture—for example by avoiding changing the volume of the audio in a middle of a word or of a sentence.

In many cases, the video editing involves adding a music-track to the user's footage, which enhances the edited video. In such case, one might like to modify the internal mixture in the audio of the edited video: Changing the mixture between the audio channel corresponding to the user's footage and the audio channel corresponding to an external music. A possible logic would be to reduce the volume of the audio channel corresponding the user's footage, while keeping unchanged the volume of the audio channel corresponding to the music (This is based on the assumption that conflicts of the narration and the music are less disturbing).

### Video Narration

The narration may consist not only on an audio track, but may also be a video—including both a visual and an audio track. The most common case is when the narration video shows the person that is talking to the camera. Adding not only the audio, but a video may further enhance the result but raises additional decisions that should be made automatically, for example—when to display the narration video and when to display the user footage.

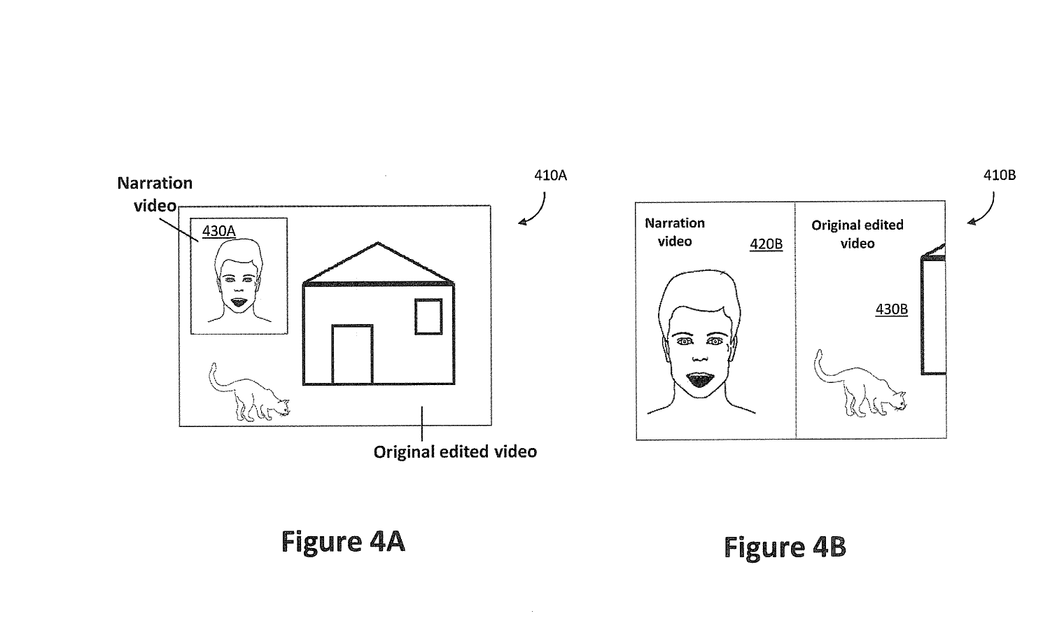

There are several methods that can be used to integrate the narration video into the edited video. Some of them are described next (and they can also be combined): adding an overlay window that shows the narration video. This approach is demonstrated in FIG. 4A where in this example the narration window 430A is located in the top-left part of the frame 410A; and splitting the video into the narration part and the user footage part, as demonstrated in FIG. 4B showing a frame 410B split between edited video 430B and narration video 420B. The main difference between the overlay and the splitting is that in the splitting approach, the original edited video part is usually shifted so that the important region in the user footage is not occluded by the narration (and is also centralized). This is done either by moving the center of the original edited video to the center of the split window, or based on an analysis of the video, centralizing important objects that were detected in the frame (e.g.—based on various object detection method.

Alternating between displaying the visual track of the narration video, and displaying the visual track of the media portions selected from the user footage (but still using the audio track from the narration). For example, the narration can be displayed only when there is no important or saliency action happening in the user footage, and when the user footage is relatively boring, is less emotional, etc. (all can be measured automatically using various methods). Another example is using speech recognition of the narration, and displaying the narration only when there is an important sentence in the narration (according to the speech recognition). The decision when to show the narration video can also be determined based on a visual analysis of the narration—for example, showing the narration when there is an interesting actions such as a laugh or a cry, or during interesting or salient movement.

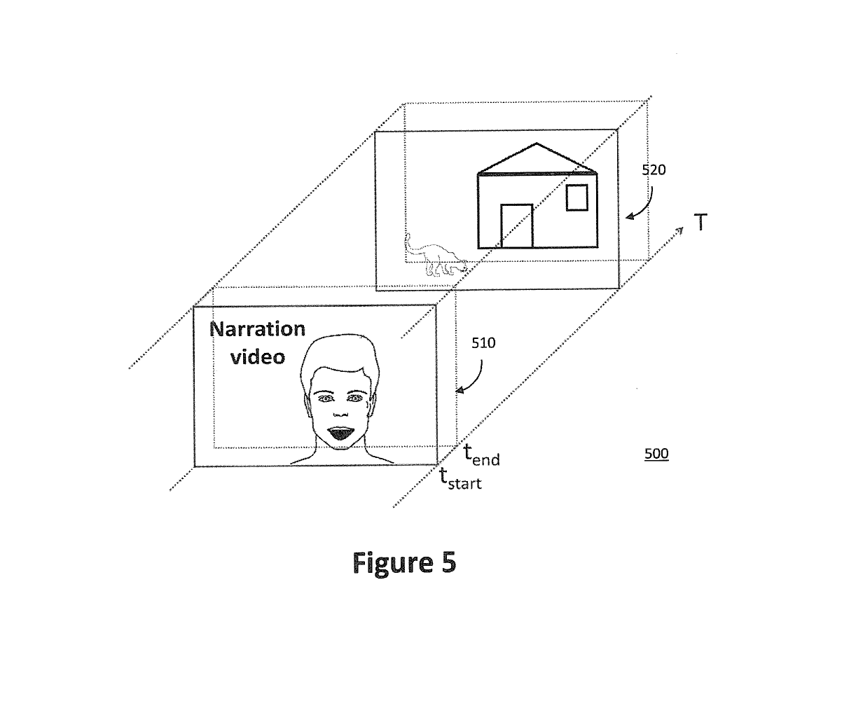

This scheme is demonstrated in FIG. 5. The narration video 510 is displayed only at some time portions, in this example—between tₛₜₐᵣₜ to t_{end}. It should be noted that the audio track of the narration is played even at moments when the visual track is not shown such as 520. This technique is known in the editing literature as a B-roll effect, which is used frequently in manual video editing.

As mentioned before, the above approaches for integrating a video narration can be combined—switching between fully shown narration, split view, overlay view and no view (only the narration audio is heard). The decision upon each approach can be based on the importance measures of the narration video and the user footage: At moment when one of them is very important, show only it, while at moment when both are important (or both less important)—merge them using the split window or the overlay window.

Integrating the narration video into the edited video by alternating between displaying the user footage and the narration. In this example, the narration is displayed only between tₛₜₐᵣₜ to t_{end}. Criterions for determining the times in which the narration is displayed are discussed in the body of text. It should be noted that the audio track of the narration is usually played even at moments when the narration video itself is not displayed.

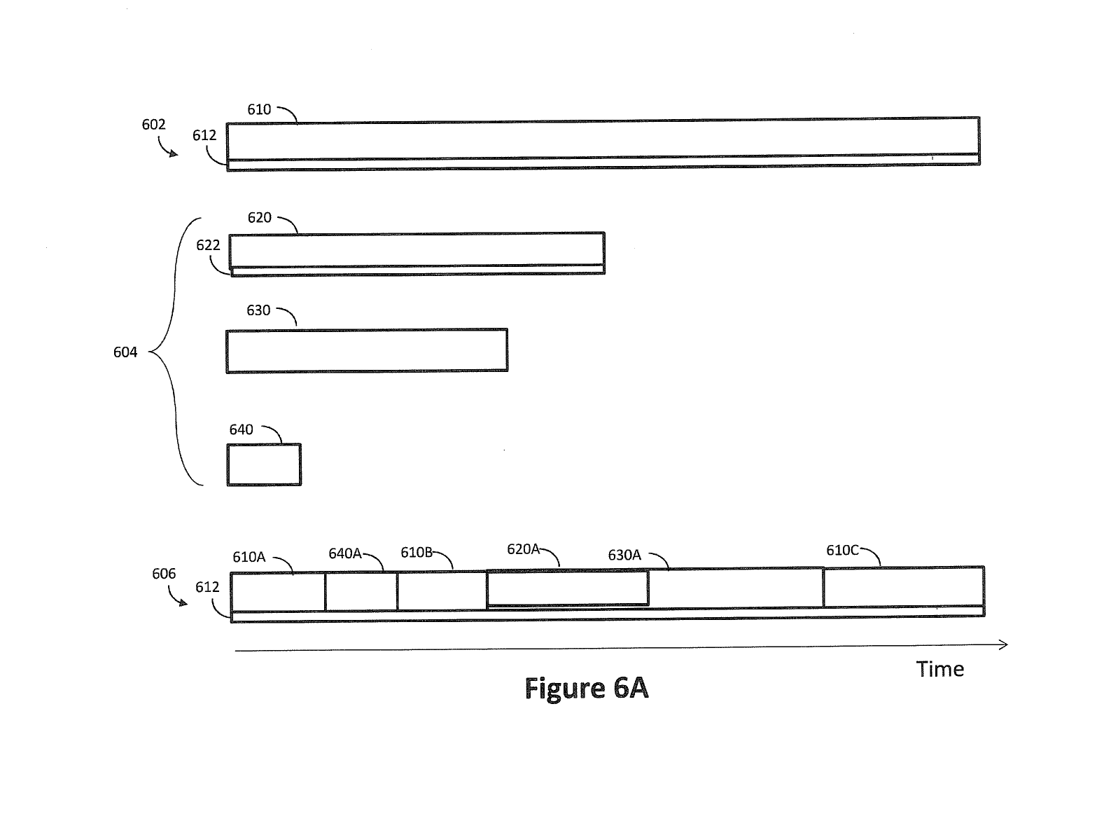

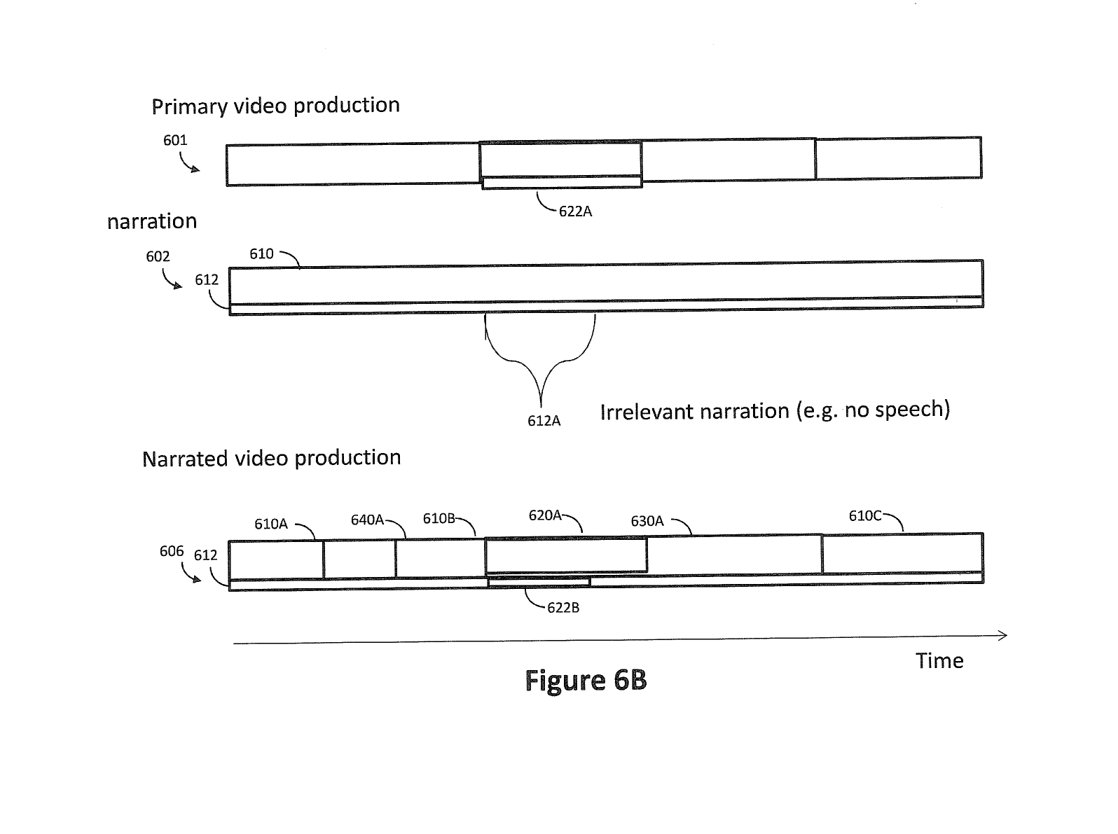

FIG. 6A is a timeline diagram showing various media entities 604 as they are being combined with a narration 602 to form a narrated video production 606. Narration 602 includes both video 610 and audio 612. Media entities 604 may include video 620 with audio 622, video without audio 630 and still image 640. Narrated video production 606 shows how subset of media entities 640A, 620A, and 630A are combined while maintaining the audio channel of the narration throughout the combined video production 606. This creates a B-Roll effect as explained above, as the subset media entities serve as cutaways.

FIG. 6B is a timeline diagram showing primary video production 601 having a plurality of media entities and specifically a video portion having an accompanying audio channel 622A. Narration 602 includes both video 610 and audio 612 and a portion 612A detected to be irrelevant narration (no speech was detected automatically in the audio track). Thus, in narrated video production 606 showing subset of media entities 640A, 620A, and 630A the audio channel 622A overrides the narration in portion 622B.

According to some embodiments of the present invention, once the narrated video production is generated and presented to the user, the user interface may be configured to enable temporal shifts in at least portions of the narrated video production. For example, a portion of the narration can be moved forward in time to be synchronized with contextually related video portion of the media entities.

According to some embodiments of the present invention, the method may further include the step of associating one or more of the selected media portions with the narration to form a single bundle, and applying a temporal shift to the bundle in its entirety.

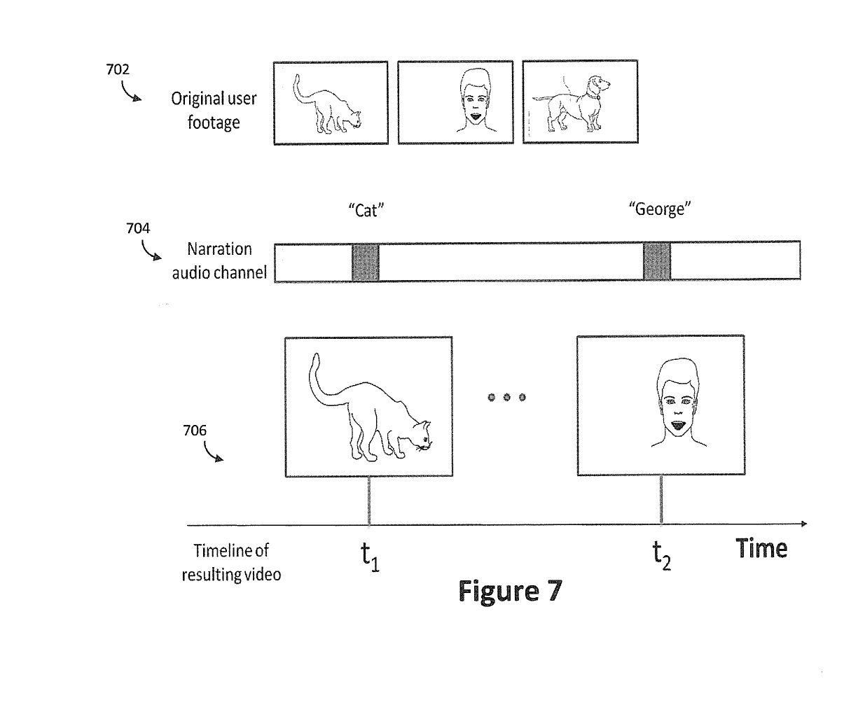

FIG. 7 is a timeline diagram illustrating how contextual similarities detected on both narration 704 and media entities 702 are used to stitch them together in the video production 706. For example, the photos of the cat and the man called “George” (detected to be such by the object & face recognition applied on the user footage) are positioned along the time-line of the edited video at times t1 and t2 correspondingly, to match the times of the detected words “Cat” and “George” in the narration (based on a speech recognition applied on the narration audio track). Obviously, the same approach can be applied for input user videos and for various types of objects, actions, scenes, and the like.

According to some embodiments of the present invention, video editing itself can be modified to take into account the added narration. For example, in this demonstration the photos of the cat and the man called “George” (detected to be such based on a visual analysis—see more details in the body of text) are positioned along the time-line of the edited video in times t1 and t2 correspondingly, to match the time of the detected words “Cat” and “George” in the narration (based on a speech recognition applied on the narration audio track). Obviously, the same approach can be applied for raw videos and for various types of objects, actions, scenes, and the like.

In accordance with some embodiments of the present invention, the aforementioned method may be implemented as a non-transitory computer readable medium which includes a set of instructions, when executed, cause the least one processor to: obtain a plurality of media entities comprising at least one video entity having a visual channel and an audio channel; analyze the media entities, to produce content-related data indicative of a content of the media entities; automatically select at least a first and a second visual portion and an audio portion, wherein the first visual and the audio portions are synchronized and have non-identical durations, and wherein the second visual and the audio portions are non-synchronized; and create a video production by combining the automatically selected visual portions and audio portions.

In order to implement the method according to some embodiments of the present invention, a computer processor may receive instructions and data from a read-only memory or a random access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, some aspects of the present invention may be embodied as a system, method or computer program product. Accordingly, some aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some aspects of the present invention are described above with reference to flowchart illustrations and/or portion diagrams of methods, apparatus (systems) and computer program products according to some embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” an “embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

Furthermore, it is to be understood that the invention can be carried out or practiced in various ways and that the invention can be implemented in embodiments other than the ones outlined in the description above.

If the specification or claims refer to “an additional” element, that does not preclude there being more than one of the additional element.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
obtaining a plurality of media entities comprising at least one video entity having a visual channel and an audio channel;
analyzing the media entities, to produce content-related media meta data indicative of a content of the media entities;
automatically selecting media portions from the plurality of media entities, wherein at least one media portion is a subset of the said video entity of said plurality of media entities;
receiving from a user a narration being a media entity comprising at least one audio channel; and
automatically combining the narration and the selected media portions, to yield a narrated video production, wherein the combining is based on the content-related media meta data.

2. The method according to claim 1, wherein the narration comprises a video footage having an audio channel and a visual channel.

3. The method according to claim 1, further comprising automatically generating a primary video production based on the content-related media meta data prior to the receiving of the narration from the user.

4. The method according to claim 3, wherein the receiving of the narration from the user is carried out responsive to presenting said primary video production.

5. The method according to claim 1, further comprising analyzing the narration to yield content-related narration meta data indicative of a content of the narration, wherein the combining further takes into account the content-related narration meta data and comprises prioritizing content that was detected in the narration over the selected media portions.

6. The method according to claim 2, wherein said combining comprises allocating at least a first and a second consecutive portions of the narrated video production both having an audio channel taken from the narration, wherein the visual channel of only one of the portions of the narrated video production is taken from the plurality of media entities.

7. The method according to claim 2, wherein said combining comprises allocating at least a first and a second consecutive portions of the narrated video production both having an audio channel taken from the narration, wherein the visual channel of only one of the portions of the narrated video production displays at least part of the visual channel of the narration.

8. The method according to claim 1, further comprising presenting the automatically selected media portions to the user and wherein the receiving of the narration from the user is carried out responsive to presenting said selected media portions.

9. The method according to claim 1, further comprising automatically detecting speech in the narration, and wherein the combining comprises reducing a volume of the audio taken from the plurality of media portions that are combined with narration portions in which speech was detected.

10. The method according to claim 1, further comprising automatically separating the narration to portions, and automatically synchronizing at least one narration portion to at least one selected media portion.

11. The method according to claim 10, wherein the separation is based at least partially on segmenting the audio channel of the narration to sentences.

12. The method according to claim 1, wherein said narration is being associated with one of the selected visual portions responsive to input from the user.

13. The method according to claim 1, wherein the combining prioritizes the narration over the selected media portions.

14. The method according to claim 1, wherein the combining further includes automatically synchronizing media portions with the narration based on contextual similarities.

15. The method according to claim 1, further comprising associating one or more of the selected media portions with the narration to form a single bundle, and applying a temporal shift to the bundle in its entirety.

16. The method according to claim 1, further enabling manual temporal shifts of narrated video production portions, responsive to presenting the narrated video production to the user.

17. The method according to claim 1, further comprising analyzing the narration, to yield content-related narration meta data indicative of a content of the narration, and wherein the generated video production further comprises adding visual effects that are dependent on the narration meta-data.

18. The method according to claim 2, wherein the determining of the portions for which the visual track of the narration is used is based on at least one of: a saliency measure, an emotion measure, recognizing specific words.

19. A system comprising:
a computer processor;
a database unit configured to store a plurality of media entities comprising at least one video entity having a visual channel and an audio channel;
an analysis module executed by the computer processor and configured to analyze the media entities, to produce content-related media meta data indicative of a content of the media entities;
an automatic selection module executed by the computer processor and configured to automatically select media portions from the plurality of media entities, wherein at least one media portion is a subset of the said video entity of said plurality of media entities;
a user interface configured to receive from a user a narration being a media entity comprising at least one audio channel; and
a video production module executed by the computer processor and configured to automatically combine the narration and the selected media portions, to yield a narrated video production, wherein the combining is based on the content-related media meta data.

20. The system according to claim 19, wherein the video production module is further configured to automatically generate a primary video production based on the content-related media meta data prior to the receiving of the narration via said user interface.

21. The system according to claim 20, wherein the receiving of the narration from the user is carried out responsive to presenting said primary video production.

22. The system according to claim 21, wherein said analysis module is further configured to analyze the narration, to yield content-related narration meta data indicative of a content of the narration, wherein the combining by the video production module further takes into account the content-related narration meta data and comprises prioritizing content that was detected in the narration over the selected media portions.

23. A non-transitory computer readable medium comprising a set of instructions that when executed cause at least one computer processor to:
store a plurality of media entities comprising at least one video entity having a visual channel and an audio channel;
analyze the media entities, to produce content-related media meta data indicative of a content of the media entities;
automatically selecting media portions from the plurality of media entities, wherein at least one media portion is a subset of the said video entity of said plurality of media entities;
receive from a user a narration being a media entity comprising at least one audio channel; and
automatically combine the narration and the selected media portions, to yield a narrated video production, wherein the combining is based on the content-related media meta data.
